(19) United States
(12) Patent Application Publication
(10) Pub. No.: US 2026/0172242 A1
(43) Pub. Date: Jun. 18, 2026

(54) SYSTEMS AND METHODS FOR OPTIMIZATION ON RIVEST-SHAMIR-ADLEMAN (RSA) KEY GENERATION

(71) Applicant: STMicroelectronics International N.V., Geneva (CH)

(72) Inventors: Qian ZHENG, Chaoyang/Beijing (CN); Huoming XIE, Beijing (CN)

(21) Appl. No.: 18/984,212

(22) Filed: Dec. 17, 2024

(51) Int. Cl. H04L 9/08; H04L 9/14; H04L 9/30

(52) U.S. Cl. CPC H04L 9/0861; H04L 9/0894; H04L 9/14; H04L 9/3073

(57) ABSTRACT

Apparatuses, systems, and methods for optimization on Rivest-Shamir-Adleman (RSA) key generation. An exemplary method includes obtaining, at a cryptographic key generation service in a secure element of a device, a first one or more commands to generate and store one or more cryptographic keys in the cryptographic key generation service; in response to the first one or more commands: generating the one or more cryptographic keys at the cryptographic key generation service; and storing the one or more cryptographic keys at the cryptographic key generation service; obtaining, at the cryptographic key generation service, a second command to generate a cryptographic key for an application associated with the device; and in response to the second command, outputting at least a portion of one of the one or more cryptographic keys stored at the cryptographic key generation service.

### TECHNOLOGICAL FIELD

Example embodiments of the present disclosure relate generally to systems, apparatuses, and methods for optimization on Rivest-Shamir-Adleman (RSA) key generation.

### BACKGROUND

Some devices utilize secure elements, such as embedded Secure Elements (eSE) or secure processing units (iSE) to improve security. For instance, a device may use a secure element to secure sensitive data and to enable secure communication. Some secure elements are tamper-resistant and include a central processing unit (CPU), storage, and a true random-number generator. Additionally, some secure elements may include mechanisms to resist package tampering and unauthorized sideloading of applications, a secure timer, and a reboot notification pin (or equivalent), such as a general-purpose input/output (GPIO). Some secure elements may be configured to support hardware-backed keystores (also referred to as password managers), such as StrongBox. For instance, StrongBox may be implemented in a secure element and used by a device for various use cases, such as to protect the user credentials and data and/or to protect application keys and support platform attestation. In some instances, an application on a device including StrongBox may invoke StrongBox to generate cryptographic key pairs, such as Rivest-Shamir-Adleman (RSA) kay pairs.

New systems and methods for RSA key generation in secure elements, such as StrongBox, are needed. The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

Various embodiments described herein relate to systems, apparatuses, and methods for optimization on Rivest-Shamir-Adleman (RSA) key generation.

In accordance with some embodiments of the present disclosure, an example method is provided. The example method comprises obtaining, at a cryptographic key generation service in a secure element of a device, a first one or more commands to generate and store one or more cryptographic keys in the cryptographic key generation service. The example method also comprises, in response to the first one or more commands generating the one or more cryptographic keys at the cryptographic key generation service and storing the one or more cryptographic keys at the cryptographic key generation service. The examples method further comprises obtaining, at the cryptographic key generation service, a second command to generate a cryptographic key for an application associated with the device and, in response to the second command, outputting at least a portion of one of the one or more cryptographic keys stored at the cryptographic key generation service.

In at least one example embodiment, obtaining the first one or more commands comprises obtaining the first one or more commands in accordance with a scheduled task.

In at least one example embodiment, obtaining the first one or more commands in accordance with the scheduled task comprises obtaining the first one or more commands over a fixed duration.

In at least one example embodiment, the method comprises, in response to outputting the portion of the one of the one or more cryptographic keys, applying a flag to the one of the one or more cryptographic keys, wherein the flag indicates a status associated with the one of the one or more cryptographic keys.

In at least one example embodiment, the status indicates that the one of the one or more cryptographic keys is unavailable for one or more other applications associated with the device.

In at least one example embodiment, the method comprises incrementing a counter in response to storing the one or more cryptographic keys, wherein a count of the counter is based at least in part on a quantity of cryptographic keys included in the one or more cryptographic keys.

In at least one example embodiment, the method comprises obtaining, at the cryptographic key generation service, a third command to generate and store another cryptographic key in the cryptographic key generation service; and in response to the third command, outputting a message comprising an error code based at least in part on the count of the counter satisfying a threshold.

In at least one example embodiment, the method comprises decrementing the counter in response to outputting the portion of the one of the one or more cryptographic keys.

In at least one example embodiment, obtaining at least one of the first one or more commands is based at least in part on a level of performance of at least one application associated with the device failing to satisfy a threshold.

In at least one example embodiment, the secure element comprises an embedded secure element (eSE) or an integrated secure element (iSE).

In at least one example embodiment, the one of the one or more cryptographic keys comprises a cryptographic key pair including a public key and a private key, and wherein the portion of the one of the one or more cryptographic keys comprises the public key.

In at least one example embodiment, the one or more cryptographic keys comprise one or more Rivest-Shamir-Adleman (RSA) key pairs.

In at least one example embodiment, the cryptographic key generation service is KeyMint.

In at least one example embodiment, the method comprises outputting, to a cryptographic key generation service in a secure element of a device, a first one or more commands to generate and store one or more cryptographic keys in the cryptographic key generation service; outputting, to the cryptographic key generation service, a second command to generate a cryptographic key for an application associated with the device; and in response to the second command, obtaining at least a portion of one of the one or more cryptographic keys from the cryptographic key generation service.

In at least one example embodiment, outputting the first one or more commands comprises outputting the first one or more commands in accordance with a scheduled task.

In at least one example embodiment, outputting the first one or more commands in accordance with the scheduled task comprises outputting the first one or more commands over a fixed duration.

In at least one example embodiment, the method comprises outputting, to the cryptographic key generation service, a third command to generate and store another cryptographic key in the cryptographic key generation service; in response to the third command, obtaining a message comprising an error code; and in response to the error code, refraining from outputting other commands to generate and store other cryptographic keys at the cryptographic key generation service.

In at least one example embodiment, outputting at least one of the first one or more commands is based at least in part on a level of performance of at least one application associated with the device failing to satisfy a threshold.

In at least one example embodiment, the one of the one or more cryptographic keys comprises a cryptographic key pair including a public key and a private key, and wherein the portion of the one of the one or more cryptographic keys comprises the public key.

In accordance with some embodiments of the present disclosure, an example system is provided. The example system comprises a cryptographic key generation service in a secure element, wherein the cryptographic key generation service configured to: obtain a first one or more commands to generate and store one or more cryptographic keys in the cryptographic key generation service. The cryptographic key generation service is also configured to, in response to the first one or more commands, generate and store the one or more cryptographic keys. The cryptographic key generation service is further configured to obtain a second command to generate a cryptographic key for an application associated with the system, and in response to the second command, output at least a portion of one of the one or more cryptographic keys.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those summarized here, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates an exemplary system that supports systems and methods for optimization on RSA key generation in accordance with one or more embodiments of the present disclosure;

FIG. 2 illustrates an exemplary process diagram that supports systems and methods for optimization on RSA key generation in accordance with one or more embodiments of the present disclosure;

FIG. 3 illustrates an exemplary flowchart of operations that supports systems and methods for optimization on RSA key generation in accordance with one or more embodiments of the present disclosure; and

FIG. 4 illustrates an exemplary device that supports systems and methods for optimization on RSA key generation in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like, generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

As used herein, the term “cryptographic key,” and the like, means a string of characters used within an cryptographic algorithm for encoding or decoding data.

As used herein, the term “cryptographic key generation service,” and the like, means a software application or applet configured to generate cryptographic keys. A cryptographic key generation service or, more simply, a key generation service, may use one or more types of algorithms to generate one or more types of cryptographic keys, which may have different key sizes. Some non-limiting examples of algorithms used for cryptographic key generation include an RSA algorithm, an advanced encryption standard (AES), an elliptic curve digital signature algorithm (ECDSA), an elliptic curve Diffie-Hellman (ECDH) algorithm, a hash-based message authentication code (HMAC), and a triple data encryption standard (DES).

As used herein, the term “secure element,” and the like, means a tamper-resistant hardware platform, such as a chip, which is capable of securely hosting applications and storing confidential and cryptographic data. A secure element may securely host applications and store confidential and cryptographic data by implementing standardized criteria and security constraints. For example, a secure element may include a hardware platform for which one or more evaluation assurance level (EAL) certificates (or one or more other types of certificates for one or more other types of standards) has been obtained. Some non-limiting examples of secure elements include eSEs and iSEs.

As used herein, the term “scheduled task,” and the like, means an operation that is performed by a device in accordance with a schedule. A scheduled task may be scheduled to occur periodically or aperiodically.

As used herein, the term “flag,” and the like, means a variable that indicates a condition. In some examples, a flag includes one or more bits that store a binary value or a Boolean variable for indicating the condition. In some examples, the condition corresponds to a status.

As used herein, the term “error code,” and the like, means a string of characters that indicate characteristics of an error that occurred. In some examples, an error code includes a numeric or alphanumeric string. In some examples, an error code indicates a type of error that occurred.

### Overview

Secure elements may include one or more software applications, also referred to as applets, to support various functionalities of the secure elements. Such functionalities may also be referred to herein as services. For example, StrongBox, which refers to a device such as an eSE or on-SoC secure processing unit (e.g., iSE), may include one or more applets to carry out one or more StrongBox services. In some examples, the secure element may include one or more other applets, such as an applet to protect user credentials and data, as well as an applet to protect application keys and support platform attestation. For example, StrongBox may include a Weaver applet for protecting user credentials and data. In some examples, the secure element may include an applet (e.g., the applet used for protecting application keys and support platform attestation or another applet) for executing cryptographic key generation functionalities within the secure element. For example, StrongBox may include a KeyMint applet for executing cryptographic key generation functionalities.

In some examples, an application of a device including a secure element may invoke the secure element to generate a cryptographic key, such as an RSA key pair. In some such examples, however, the key generation process (e.g., in the KeyMint applet) may take a relatively long time. For instance, completing the key generation process in the StrongBox KeyMint applet may take several seconds (e.g., at least 5 seconds or more). In some instances, due to the key generation process, one or more other commands sent to the secure element during the key generation process may not be responded to (e.g., may not be processed by the secure element). In other words, the secure element may be incapable of performing the key generation process and responding to one or more commands concurrently.

As an illustrative example, during key generation, a user of the device may determine to unlock the screen of the device (e.g., via a fingerprint or pin), which may result in a command (e.g., a Weaver command) being sent to the secure element from a lock setting service of the device. In such an example, due to the key generation process, the secure element may refrain from responding to the command. For example, the secure element may be incapable of responding to one or more commands while the key generation process is ongoing. In such an example, a failure to receive a response from the secure element may cause the lock setting service to fail, which may degrade user experience.

Various aspects of the present disclosure are directed to improved systems, apparatuses, and methods for optimization on key generation and, more specifically, for optimization on RSA key generation. Among other aspects, the present disclosure provides for a generate and store key command (e.g., a “GENERATE AND STORE RSA KEY PAIR”), which may be used to pre-generate and store one or more RSA key pairs in a key generation service in a secure element (e.g., in an eSE and/or iSE environment). For example, the present disclosure may provide for implementation of a generate and store key command in a key generation service of a secure element (e.g., inside a StrongBox KeyMint applet).

In some examples, the generate and store key command may be set as a schedule task. For example, the systems, apparatuses, and methods for optimization on key generation, as described herein, may provide for the generate and store key command to be sent to the key generation service during one or more fixed time slots. As an illustrative example, the systems, apparatuses, and methods for optimization on key generation, as described herein, may provide for the generate and store key command to be sent to the key generation service during one or more time slots between midnight and 1:00 AM.

In some examples, the key generation service may be configured with a threshold quantity of keys (e.g., a maximum quantity of keys) that may be stored in the key generation service (or elsewhere in the secure element). In some such examples, if the threshold quantity is reached, the key generation service may return an error code (e.g., ‘IF’, indicating too many operations). In response to the error code, a source of the key generation service (e.g., a Strongbox client) may refrain from sending one or more additional generate and store key commands to the key generation service (e.g., for some duration, such as until another task including transmission of a generate and store key command is scheduled to occur).

In some examples, the generate and store key command may trigger the key generation service to generate and store one or more RSA keys. In some such examples, in response to the key generation service receiving a generate key command with RSA invoked, the key generation service may refrain from performing the key generation process and, instead, may return one of the previously stored RSA keys. In other words, the generate and store key command may be used to generate an RSA key pair and store the RSA keypair in the key generation service, such that the (pre-) generated RSA key pair may be available for a next (e.g., subsequently received) generate key command that requests an RSA key.

In some examples, the key generation service may use a counter to monitor the quantity of keys stored in the key generation service (or elsewhere in the secure element). In some such examples, the key generation service may increment the counter (e.g., increase the count of the counter by 1) in response to a generate and store key command. Additionally, in some such examples, the key generation service may decrement counter (e.g., decrease the count of the counter by 1) in response to a generate key command.

In some examples, the key generation service may apply a flag to a key provided to an application in response to a generate key command. In some examples, one or more pre-generated keys stored in the key generation service (or elsewhere in the secure element) may be available irrespective of an operational state of the device. For example, one or more pre-generated keys stored in the key generation service (or elsewhere in the secure element) may be available after reset or reboot of the device. In some examples, by enabling the secure element to pre-generate and store one or more keys in the key generation service, the systems, apparatuses, and methods for optimization on key generation, as described herein, may provide for an improved user experience and a reduced a likelihood of concurrency issues, such as issues associated with the secure element failing to respond to multiple commands received concurrently.

### Exemplary Systems, Methods, and Apparatuses

Embodiments of the present disclosure herein include systems, methods, and apparatuses for optimization on RSA key generation, which may be implemented in various embodiments.

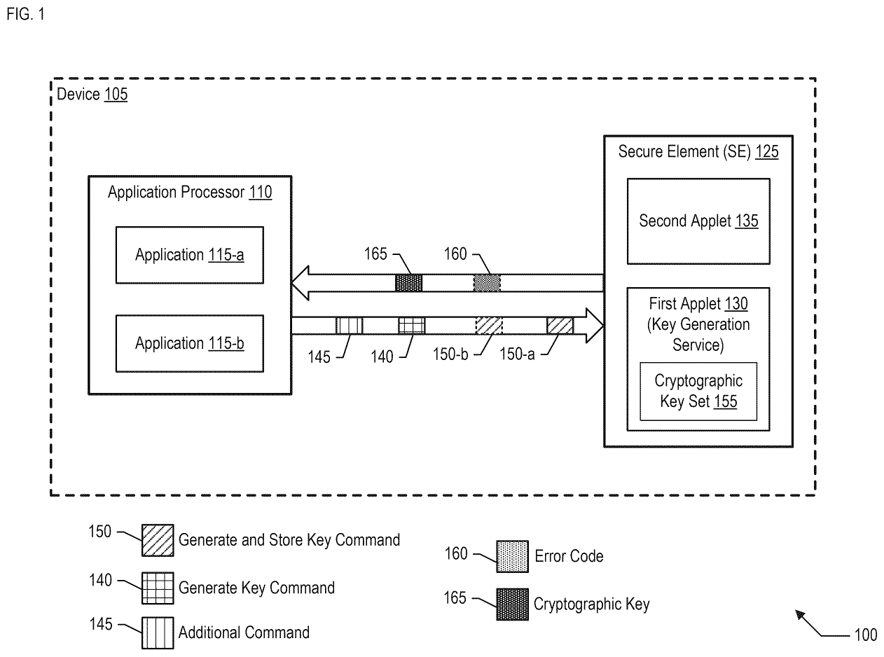

FIG. 1 illustrates an exemplary system 100 that supports systems, methods, and apparatuses for optimization on RSA key generation in accordance with one or more embodiments of the present disclosure. As illustrated in the example of FIG. 1, a device 105 may include an application processor 110 and a secure element 125. The application processor 110 may include (e.g., support) an application 115-a and an application 115-b, as well as one or more other components. For example, the application processor 110 may include one or components configured to support communication between the applications 115 (e.g., software applications) and the secure element 125. Some such components may include one or more hardware abstraction layers (HALs) and/or one or more computer programs running in the background and performing various tasks without direct interaction from a user.

The secure element 125 may be an example of an embedded secure element (eSE). For example, the secure element 125 may be an example of a dedicated chip within the device 105 that provides secure storage and processing for sensitive data. In some other examples, the secure element 125 may be an example of an integrated secure element (iSE). For example, the secure element 125 may be a security subsystem built directly into the chip (e.g., the System-on-a-Chip (SoC), the integrated circuit (IC)) of the device 105, thereby becoming part of the host system. In other words, in some examples, the secure element 125 may be one of multiple on-SoC secure processing units (e.g., including the application processor 110) of the device 105. The secure element 125 may include (e.g., support) one or more software applications, referred to herein as applets, which are configured to perform one or more particular tasks.

The secure element 125 may also include a CPU, secure storage (e.g., one or more a secure storage applets, high-stress memory (HSM) or other types of memory), a true random-number generator, and a reboot notification pin (or equivalent), such as a GPIO. Additionally, the secure element 125 may support one or more mechanisms to resist package tampering and unauthorized sideloading of applications. In some examples, one or more external interfaces and one or more features for electrostatic discharge (ESD) protection. The secure element 125 may be configured to support application protocol data unit (APDU) communication over inter-integrated circuit (I2C) and/or serial peripheral interface (SPI). In some examples, the secure element may be referred to as StrongBox. That is, the term StrongBox may refer to devices such as eSEs or on-SoC secure processing units (e.g., iSE).

In some examples, the secure element 125 may be configured to manage one or more types of applets, including Java® Card applets, provided from one or more entities (e.g., users and/or original equipment manufacturers (OEMs), hardware integrators, or service providers). For example, the secure element 125 may include (e.g., support) a first applet 130, which may be an example of a key generation service such as the StrongBox KeyMint applet (also referred to as the KeyMint applet or, more simply, KeyMint). Additionally, the secure element 125 may include (e.g., support) a second applet 135, which may be an example of an applet used to protect user credentials and data such as the StrongBox Weaver applet (also referred to as the Weaver applet or, more simply, Weaver).

In some examples, the secure element 125 may support one or more low-power implementations. In some such examples, the secure element 125 may be configured to support a subset of algorithms and key sizes, including one or more types of RSA keys (e.g., RSA 2048), one or more types of AES keys (e.g., AES 128 and 256), one or more types of ECDSA keys, one or more types of ECDH keys (e.g., ECDH P-256), one or more types of HMAC keys (e.g., HMAC-SHA256). In some examples, the secure element 125 may support key sizes between 8 bytes and 64 bytes. The secure element 125 may also support triple DES, and extended length APDUs, as well as key attestation.

In the example of FIG. 1, the application 115-a (e.g., a payment application) may invoke the secure element 125 (e.g., a StrongBox service) to generate one or more cryptographic keys. For example, the application may invoke the secure element 125 to trigger the first applet 130 (e.g., KeyMint) in the secure element 125 to generate an RSA key pair. In some such examples, the application 115-a may send a generate key command 140 to the secure element 125 (e.g., to the first applet 130 in the secure element 125). The application 115-a may send the generate key command 140 via a HAL, such as a KeyMint and/or StrongBox HAL.

In some examples, in response to receiving the generate key command 140, the first applet 130 may generate a cryptographic key (e.g., an RSA key pair or another type of cryptographic key). In some such examples, the first applet 130 may generate the cryptographic key over a duration (e.g., about 5 or more seconds). In other words, the process of generating the cryptographic key may take about 5 or more seconds to complete. In some examples, during the duration, the secure element 125 may receive an additional command 145 from another application, such as the application 115-b. In some such examples, due to the key generation process, the secure element 125 may be incapable of processing the additional command 145 (e.g., may be incapable of responding to the additional command 145). In other words, if during the key generation process, some other command is sent to the secure element 125, the secure element 125 may wait to process the other command until the key generation process is complete.

As an illustrative example, the device 105 may be a mobile device, such as a mobile phone. Additionally, in such an illustrative example, the first applet 130 may be the KeyMint applet and the second applet 135 may be the Weaver applet. In such an example, the application 115-a (e.g., the payment application) may send the generate key command 140 to the KeyMint applet (thereby triggering the key generation process in the KeyMint applet) before or at the same time as a user of the mobile phone attempts to unlock the screen of the mobile device via a fingerprint or pin, which may involve the application 115-b (e.g., a lockscreen application, also referred to as a LockSettingService) calling a Weaver command. In other words, while the first applet 130 is generating a cryptographic key for the application 115-a in response to the generate key command 140, the secure element 125 (e.g., the second applet 135 in the secure element 125) may receive the additional command 145 from the application 115-b (e.g., via a HAL).

In some examples, due to the key generation process, the secure element may be incapable of responding to the Weaver command. That is, the secure element 125 (e.g., the second applet 135 within the secure element 125) may be unable to respond to the additional command 145, which may lead to increased latency and reduced performance of the application 115-b (e.g., the LockSettingService may be stuck waiting for the response and, in some instances, may fail). In other words, necessitating that the first applet 130 generate a cryptographic key in response to the generate key command may lead to increased latency and degraded user experience.

Various aspects of the present disclosure provide for improved key generation for secure elements. For example, various aspects of the present disclosure provide for an optimization on RSA key generation, which may reduce a likelihood of concurrency problems when, for example, end-users using secure elements (e.g., StrongBox) request RSA key pair generation concurrently with other process requests, such as LockSettingService requests to unlock the screen of a mobile device.

In accordance with one or more aspects of the present disclosure, the first applet 130 may be configured to pre-generate one or more cryptographic keys in the first applet 130 (or elsewhere in the secure element 125) in response to one or more generate and store key commands 150 (e.g., one or more “GENERATE AND STORE RSA KEY PAIR” command).

As illustrated in the example of FIG. 1, the application processor 110 (e.g., one or more components or services of the application processor 110) may transmit a generate and store key command 150-a to the secure element 125. In response to the generate and store key command 150-a, the first applet 130 may generate and store one or more cryptographic keys in a cryptographic key set 155.

In some examples, a generate and store key command (e.g., the generate and store key command 150-a, the generate and store key command 150-b) may trigger the first applet 130 to generate a key (e.g., an RSA key pair) and store the key in the first applet 130 to make the key available for a subsequent (e.g., next) generate key command that requests one or more RSA keys. In some examples, the key may be available irrespective of an operational state of the device 105. For example, the key may be available after reset or reboot of the device 105. In some examples, the key may be used for (e.g., output in response to) a single generate key command. In some such examples, the generate and store key command may be invoked before each generate key command (e.g., each generate key command requesting RSA key generation). Additionally, or alternatively, the generate and store key command may be invoked before each generate key command for an application having level of performance (e.g., execution time) that fails to satisfy a threshold.

In some examples, the secure element may include a Java® Card operating system and, as such, may host applications (referred to as applets), which employ Java® technology. In other words, the first applet 130 and the second applet 135 may be examples of Java® Card applets. As such, the generate and store key commands 150, and one or more other commands communicated with the secure element 125, may have a format (e.g., an APDU format) based on Java code. For example, the generate and store key commands 150 may be an example of a “GENERATE AND STORE RSA KEY PAIR” command formatted in accordance with the following Table 1:

TABLE 1

| | |
|---|---|
| CLA | ‘80’ |
| INS | ‘D4’ |
| P1-P2 | ‘5000’ or ‘6000’ |
| Lc | Absent |
| Command Data | Absent |
| Le | ‘00’ |
| Response Data | Array containing: |
| | 1) Result (unsigned) |

In some examples, the status word (SW) for the generate and store key commands 150 may be formatted in accordance with the following Table 2:

TABLE 2

| Result | SW | Condition |
|---|---|---|
| ‘03E8’ | ‘9000’ | Unknown error: Wrong CLA; Wong P1-P2; Command |
| | | not allowed (wrong lifecycle state) |
| ‘1F’ | ‘9000’ | Too many operations. The maximum number of key |
| | | pairs is reached. |
| ‘00’ | ‘9000’ | Command successfully executed |

In some examples, an operation condition for the command may be configured in accordance with the following Table 3:

TABLE 3

| | SE Factory | Original Equipment |
|---|---|---|
| | Provisioning | Manufacturer (OEM) |
| Lifecycle State | Status | Provisioning Status |
| PROVISIONED_READY | N/A | N/A |

It is to be understood that the values provided in Tables 1 through 3 are merely examples and should not be construed to narrow the scope or spirit of the disclosure in any way. In some instances, values provided in Tables 1 through 3 may change based on implementation. For example, a value of a “GENERATE AND STORE RSA KEY PAIR” command parameter provided to the first applet 130 may be based on the version of the first applet 130.

In some examples, the generate and store key command may be set as a schedule task (e.g., during one or more fixed durations). That is, in some examples, one or more tasks including the transmission of one or more generate and store key commands 150 to the secure element 125 (e.g., to the first applet 130 within the secure element 125) may be scheduled to occur periodically or a periodically. In other words, the first applet 130 may be scheduled to receive one or more generate and store key command 150 during one or more time slots (e.g., one or more fixed time slots). In some examples, the one or more tasks may be scheduled to occur over one or more durations during which little to no data traffic is obtained at, or output from, the secure element 125 (or little to no data traffic is exchanged between the applications 115 and the secure element 125). As an illustrative example, the first applet 130 may be scheduled to receive one or more generate and store key commands during one or more (fixed) time slots between midnight and 1 AM.

As illustrated in the example of FIG. 1, the secure element 125 (e.g., the first applet 130 within the secure element 125) may be scheduled to receive the one or more generate and store key commands 150 from the application processor 110. For example, one or more of the applications 115 (e.g., one or more StrongBox clients) and/or one or more other components of the application processor 110 (e.g., a keystore service) may be scheduled to transmit one or more generate and store key command 150 during one or more fixed time slots. In some other examples, the first applet 130 may be scheduled to receive one or more generate and store key commands 150 from one or more other entities of the device 105 and/or from one or more other entities within the secure element 125. For example, the operating system (or another applet) of the secure element 125 may be scheduled to transmit one or more generate and store key command 150 (e.g., during one or more fixed time slots) to the first applet 130.

In some examples, the generate and store key command 150-a (e.g., a single GENERATE AND STORE RSA KEY PAIR command) may trigger the first applet 130 to generate and store one cryptographic key (e.g., one RSA key pair) in the first applet 130 (or elsewhere in the secure element 125). In some such examples, the first applet 130 may be configured to store a threshold quantity (e.g., a maximum number) of cryptographic keys. For example, the first applet 130 may include a counter, which the first applet 130 may increment in response to generating and/or storing a cryptographic key. In other words, the first applet 130 may increase a value of the counter by 1 (or another suitable value) in response to receiving the generate and store key command 150-a.

In some examples, a quantity of cryptographic keys included in the cryptographic key set 155 (and thus a value of the counter) may be equal to the threshold quantity of cryptographic keys. In such an example, in response to a generate and store key command, the first applet 130 may be configured to return an error code 160 (e.g., ‘F1’), which may indicate too many operations. For example, after the first applet 130 generates and stores a cryptographic key in the cryptographic key set 155 in response to receiving the generate and store key command 150-a, the quantity of cryptographic keys included in the cryptographic key set 155 (and thus the value of the counter) may be equal to the threshold quantity of cryptographic keys. In such an example, while the value (e.g., count) of the counter satisfies the threshold, the first applet 130 may receive a generate and store key command 150-b. Thus, in response to receiving the generate and store key command 150-b (and based on the value of the counter satisfying the threshold), the first applet 130 may transmit the error code 160 (e.g., indicating too many operations). In such an example, the error code 160 may trigger a transmitter of the generate and store key command 150-b (e.g., the StrongBox client) to refrain from transmitting subsequent generate and store key commands to the secure element 125 (e.g., until a next scheduled duration, until the StrongBox client is otherwise triggered by the secure element 125 to transmit another generate and store key command, and/or until the count of the counter fails to satisfy the threshold).

In some examples, the first applet 130 may receive the generate key command 140. In such an example, in response to receiving the generate key command 140, the first applet 130 may return one of the cryptographic keys included in the cryptographic key set 155 stored at the first applet 130 (or otherwise stored in the secure element 125). For example, in response to receiving the generate key command 140 (e.g., a “GENERATE KEY” command) with RSA invoked, the first applet 130 may refrain from performing the key generation process and may instead return one of the previously stored RSA keys (e.g., immediately). For example, in response to receiving the generate key command 140 from the application 115-a, the first applet 130 may refrain from performing the key generation process and may instead return a cryptographic key 165, which may be one of the cryptographic keys included in the cryptographic key set 155. Accordingly, if the user attempts to unlock the screen at or around the same time the secure element 125 receives the generate key command 140 (e.g., concurrently with the generate key command 140) via the additional command 145, the secure element 125 may respond to both the generate key command 140 and the additional command 145, and the screen may be successfully unlocked.

The cryptographic key 165 may be an example of a symmetric key or a public key of an asymmetric keypair. For example, the cryptographic key set 155 may include one or more cryptographic key pairs (e.g., RSA key pairs), which may each include a public key and a private key. In such an example, the cryptographic key 165 may include the public key of a cryptographic key pair. Alternatively, the cryptographic key 165 may include another type of cryptographic key, which may be exposed outside of the secure element 125.

In some examples, the cryptographic key 165 (e.g., and one or more other cryptographic keys included in the cryptographic key set 155) may be single-use keys. For example, in response to transmitting the cryptographic key 165 (or a portion thereof) to the application 115-a, the first applet 130 may apply a flag to the cryptographic key 165, so that the cryptographic key 165 may not be used for another application. For example, the flag may indicate a status associated with the cryptographic key 165 and, in some examples, the status may indicate that the one of the cryptographic key 165 is unavailable for one or more other applications associated with the device 105.

In some examples, in response to transmitting the cryptographic key 165 (or a portion thereof) to the application 115-a, the first applet 130 may decrement the counter. That is, in some examples, the first applet 130 may decrease the value of the counter by 1 (or another suitable value) in response to transmitting the cryptographic key 165.

In some examples, by outputting the cryptographic key 165 in response to the generate key command 140, the secure element 125 (e.g., the second applet 135 within the secure element 125) may be capable of responding to the additional command 145 (e.g., the Weaver command). For example, by refrain from performing the key generation process and instead (immediately) returning one of the previously stored RSA keys, the secure element 125 (e.g., the second applet 135 within the secure element 125) may be capable of responding to the additional command 145 (e.g., immediately, without waiting for a key generation process to finish), which may reduce latency and improve the user experience. In other words, by pre-generating and storing one or more cryptographic keys via one or more (scheduled) generate and store key commands, the secure element 125 may reduce latency and improve user experience for the device 105.

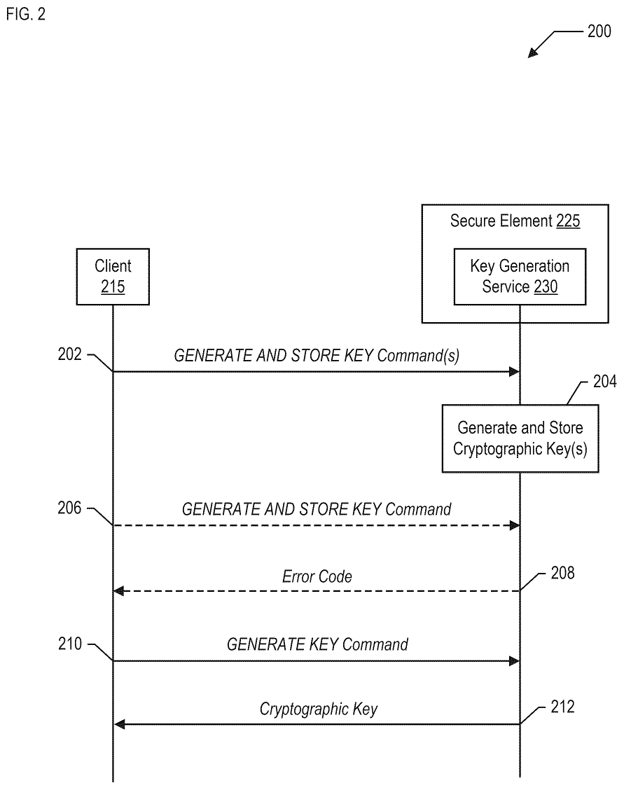

FIG. 2 illustrates an exemplary process diagram 200 that supports systems and methods for optimization on RSA key generation in accordance with one or more embodiments of the present disclosure. The process diagram 200 illustrates operations performed, such as within the system of FIG. 1 in accordance with one or more aspects of the present disclosure. For example, the process diagram 200 illustrates example operations performed by a key generation service 230 in a secure element 225. The key generation service 230 may be an example of a key generation applet (e.g., the KeyMint applet) illustrated by and described with reference to FIG. 1. Additionally, the secure element 225 may be an example of a secure element (e.g., StrongBox) illustrated by and described with reference to FIG. 1. The process diagram 200 also illustrates example operations performed by a client 215. In some examples, the client 215 may be an example of an application (e.g., a StrongBox client) illustrated by and described with reference to FIG. 1. In some other examples, the client 215 may be an example of one or more components (or services) of an application processor or secure element illustrated by and described with reference to FIG. 1. One or more operations performed at the key generation service 230 and/or the client 215 may be performed in a different order than the example order shown. Additionally, or alternatively, one or more operations performed at the key generation service 230 and/or the client 215 may be omitted and/or one or more other operations may be added. The process diagram 200 may support a optimization on RSA key generation as described herein.

In some examples, the key generation process (e.g., the process of generating RSA keys or one or more other types of keys) in the secure element 225 may occur over a relatively long duration, such as about 5 or more seconds. In some such examples, if an application invokes a generate key request to the secure element 225 during the key generation process, one or more other requests may not be responded to, which may increase latency for the system.

One or more aspects of the present disclosure provide a method to pre-generate and store one or more cryptographic keys (e.g., one or more RSA keys or one or more other types of keys) in the key generation service 230 of the secure element 225 (e.g., in the StrongBox KeyMint applet, or another type of key generation service), for example, as a scheduled task. Accordingly, in response to the secure element 225 receiving a generate key request for an application, the secure element 225 may directly return one of the previously stored cartographic keys (e.g., via the key generation service 230), thereby skipping the key generation process and reducing latency.

At 202, the key generation service 230 may obtain one or more generate and store key commands. That is, the key generation service 230 may obtain one or more commands to generate and store one or more cryptographic keys in the key generation service 230. The generate and store key command(s) may be example(s) of a generate and store key command illustrated by and described with reference to FIG. 1. For example, the key generation service 230 may obtain the one or more generate and store key commands in accordance with a scheduled task. In some examples, the key generation service 230 may obtain the one or more generate and store key commands from the client 215 over a fixed duration (e.g., one or more fixed time slots).

At 204, in response to the one or more generate and store key commands, the key generation service 230 may generate and store one or more cryptographic keys at the key generation service 230 (or elsewhere in the secure element 225). The one or more cryptographic keys may be examples of one or more cryptographic keys illustrated by and described with reference to FIG. 1. For example, the one or more cryptographic keys may include one or more keypairs (e.g., one or more RSA key pairs). In some examples, the key generation service 230 may increment a counter in response to storing the one or more cryptographic keys. In some such examples, a count of the counter may be based on a quantity of cryptographic keys included in the one or more cryptographic keys stored at the key generation service 230.

In some examples, at 206, the key generation service 230 may obtain another generate and store key command (e.g., another command to generate and store another cryptographic key in the key generation service 230). In some such examples, at 208 in response to the other generate and store key command, the key generation service 230 may output a message including an error code based on the count of the counter satisfying a threshold (e.g., having a value that is equal to a threshold quantity of cryptographic keys that may be stored at the key generation service 230 or elsewhere in the secure element 225).

At 210, the key generation service 230 may obtain a generate key command (e.g., a second command to generate a cryptographic key) for an application associated with the device. The generate key command may be an example of a generate key command illustrated by and described with reference to FIG. 1.

At 212, in response to the generate key command, the key generation service 230 may output at least a portion of one of the one or more cryptographic keys stored at the key generation service 230. For example, the one of the one or more cryptographic keys may include a cryptographic key pair (e.g., an RSA key pair) including a public key and a private key. In such an example, the portion of the one of the one or more cryptographic keys may include the public key.

In some examples, the key generation service 230 may decrement the counter in response to outputting the portion of the one of the one or more cryptographic keys. Additionally, or alternatively, in response to outputting the portion of the one of the one or more cryptographic keys, the key generation service 230 may apply a flag to the one of the one or more cryptographic keys. In such an example, the flag may indicate a status associated with the one of the one or more cryptographic keys. For example, the flag may indicate that the one of the one or more cryptographic keys is unavailable for one or more other applications associated with the device.

In some examples, the client 215 may be configured to invoke the secure element 225 to pre-generate one or more cryptographic keys (e.g., may be configured to schedule the transmission of one or more generate and store key commands) based on a level of performance of at least one application of the device (e.g., the application or one or more other applications) failing to satisfy a threshold. For example, the client 215 (or another component in electronic communication with the client 215) may determine that the level of performance of the application (or another application in the device) is reduced relative to a baseline (or threshold) level of performance. As an illustrative example, the client 215 may determine that an execution time of the application (or another application in the device) is relatively high and reducing a level of performance of the device. In such an example, to improve the performance of the application, the client 215 may output (as a scheduled task) one or more generate and store key commands, such that the key generation service 230 may (pre-) generate and store one or more cryptographic keys, which the client 215 may directly obtain via the generate key command (e.g., without necessitating that the key generation service 230 perform the key generation process). In other words, the client 215 may output the generate and store key command for one or more applications to improve the execution time of the one or more applications. In some examples, by pre-generating and storing one or more cryptographic keys via one or more (scheduled) generate and store key commands, the secure element 225 may reduce latency and improve user experience for the client 215.

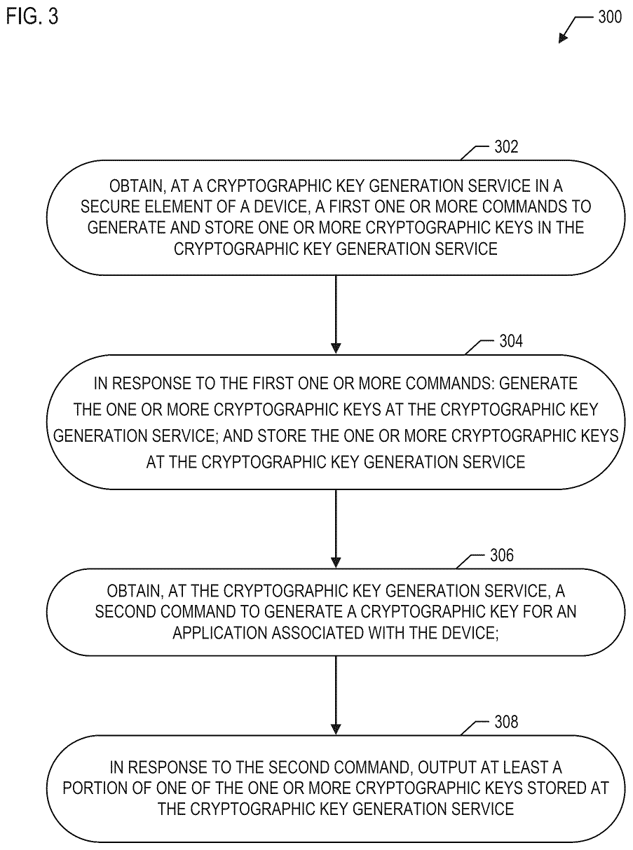

FIG. 3 illustrates an exemplary flowchart of operations that supports systems and methods for optimization on RSA key generation in accordance with one or more embodiments of the present disclosure. The operations of the flowchart 300 may be implemented at one or more components illustrated by and described with reference to FIGS. 1 and 2. For example, the operations of the flowchart 300 may be implemented by a cryptographic key generation service, which may be an example of a key generation applet, or a key generations service illustrated by and described with reference to FIG. 1 or 2, respectively. For example, the cryptographic key generation service may be an example of a first applet (e.g., the KeyMint applet) illustrated by and described with reference to FIG. 1, or a key generation service illustrated by and described with reference to FIG. 2. The key generation service may be a component of (e.g., executed in) a secure element, which may be an example of a secure element illustrated by and described with reference to FIGS. 1 and 2. For example, the secure element may be an example of an eSE or an iSE (or another type of secure element) of a device.

At 302, the cryptographic key generation service may obtain a first one or more commands to generate and store one or more cryptographic keys in the cryptographic key generation service. The first one or more commands may be examples of a generate and store key command illustrated by and described with reference to FIGS. 1 and 2. For example, the first one or more commands (e.g., one or more “GENERATE AND STORE KEY PAIR” commands, one or more “GENERATE AND STORE RSA KEY PAIR” commands) may trigger the cryptographic key generation service to generate and store one or more cryptographic key pairs, such as one or more RSA key pairs.

The cryptographic key generation service may obtain the first one or more commands in accordance with a scheduled task. For example, the cryptographic key generation service may obtain the first one or more commands over a fixed duration. In some examples, the cryptographic key generation service may obtain the first one or more commands from a client of the device. The client of the device may include the operating system or one or more applications (e.g., applets) of the secure element or a (non-secure) component of the device, such as an application processor of the device. In some examples, the cryptographic key generation service may obtain the first one or more commands based a level of performance of at least one application associated with the device failing to satisfy a threshold (e.g., falling below a threshold level of performance, which may be due to increased latency).

At 304, in response to the first one or more commands, the cryptographic key generation service may perform one or more actions. For example, the cryptographic key generation service may generate and store the one or more cryptographic keys at the cryptographic key generation service (or elsewhere in the secure element). In some examples, such as examples in which a generate and store key command is successfully executed, the cryptographic key generation service may output a message indicating that the command was successfully executed. In some other examples, such as examples in which a generate and store key command is not successfully executed, the cryptographic key generation service may output a message including an error code in response to one of the first one or more commands. For example, in response to storing a cryptographic key (e.g., in response to obtaining one of the first one or more commands), the cryptographic key generation service may increment a count of a counter at the cryptographic key generation service. In some such examples, by incrementing the count of the counter, the count of the counter may satisfy a threshold. The threshold may be based on (e.g., correspond to) a threshold (e.g., maximum) quantity of cryptographic keys that may be stored at the cryptographic key service. In some such examples, in response to another (subsequent) one of the first one or more commands, the cryptographic key generation service may output a message comprising an error code based on the count of the counter satisfying the threshold.

At 306, the cryptographic key generation service may obtain a second command to generate a cryptographic key for an application associated with the device. The second command may be an example of a generate key command (e.g., a “GENERATE KEY” command with RSA invoked) illustrated by and described with reference to FIGS. 1 and 2.

At 308, in response to the second command, the cryptographic key generation service may output at least a portion of one of the one or more cryptographic keys stored at the cryptographic key generation service. For example, the one or more cryptographic keys may include one or more cryptographic key pairs, in which each cryptographic key pair may include a public key and a private key. In such an example, the cryptographic key generation service may output the public key of one of the one or more cryptographic key pairs.

In some examples, in response to outputting the portion of the one of the one or more cryptographic keys, the cryptographic key generation service may apply a flag to the one of the one or more cryptographic keys. The flag may be an example of a flag described with reference to FIGS. 1 and 2. For example, the flag may indicate a status associated with the one of the one or more cryptographic keys. In some examples, the status indicates that the one of the one or more cryptographic keys is unavailable for one or more other applications associated with the device. That is, the flag may indicate that the one of the one or more cryptographic keys may not be provided to another application, including one or more other applications associated with the device. In some examples, the cryptographic key generation service may decrement the counter (e.g., such that the count of the counter may decrease by one) in response to outputting the portion of the one of the one or more cryptographic keys. In some examples, by pre-generating and storing one or more cryptographic keys, the secure element may refrain from performing the key generation process in response to a generate key command and instead may return one of the previously stored cryptographic keys (e.g., immediately), which may lead to reduced latency and improved performance, among other benefits.

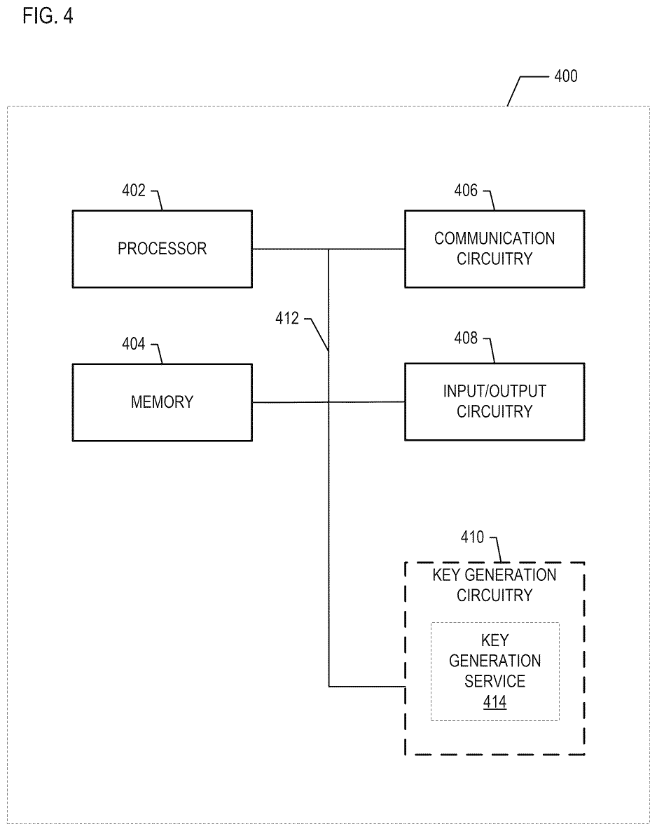

FIG. 4 illustrates an exemplary device that supports systems and methods for optimization on RSA key generation in accordance with one or more embodiments of the present disclosure. FIG. 4 may be implemented by one or more aspects illustrated by and described with reference to FIGS. 1-3. For example, the device 400 may be a device for an application, apparatus, and/or a system. The device 400 may be a mobile device, such as a mobile phone, or another type of device used for various security applications, such as payment, digital keys (e.g., vehicle keys, house keys), battery charging, or ticketing. The device 400 may be a system and/or apparatus that includes a processor 402, memory 404, communication circuitry 406, input/output circuitry 408, and key generation circuitry 410, and all of which may be connected by a bus or buses 412. It should be appreciated that, in some embodiments, the device 400 may include or be otherwise coupled to one or more other components, such as a power source(s) and/or a load(s). The power source(s) and/or a load(s) may be internal or external to the device 400.

The processor 402, although illustrated as a single block, may be comprised of a plurality of components and/or processor circuitry. The processor 402 may be implemented as, for example, various components comprising one or a plurality of microprocessors with accompanying digital signal processors; one or a plurality of processors without accompanying digital signal processors; one or a plurality of coprocessors; one or a plurality of multi-core processors; processing circuits; and various other processing elements. The processor may include integrated circuits. In various embodiments, the processor 402 may be configured to execute applications, instructions, and/or programs stored in the processor 402, or otherwise accessible to the processor 402. When executed by the processor 402, these applications, instructions, and/or programs may enable the execution of one or a plurality of the operations and/or functions described herein. Regardless of whether it is configured by hardware, firmware/software methods, or a combination thereof, the processor 402 may comprise entities capable of executing operations and/or functions according to the embodiments of the present disclosure when correspondingly configured.

The memory 404 may comprise, for example, a volatile memory, a non-volatile memory, or a certain combination thereof. Although illustrated as a single block, the memory 404 may comprise a plurality of memory components. In various embodiments, the memory 404 may comprise, for example, a random access memory, a cache memory, a flash memory, a hard disk, a circuit configured to store information, or a combination thereof. The memory 404 may be configured to write or store data, information, application programs, instructions, etc. so that the processor 402 may execute various operations and/or functions according to the embodiments of the present disclosure. For example, in at least some embodiments, a memory 404 may be configured to buffer or cache data for processing by the processor 402. Additionally, or alternatively, in at least some embodiments, the memory 404 may be configured to store program instructions for execution by the processor 402. The memory 404 may store information in the form of static and/or dynamic information. When the operations and/or functions are executed, the stored information may be stored and/or used by the processor 402.

The communication circuitry 406 may be implemented as a circuit, hardware, computer program product, or a combination thereof, which is configured to receive and/or transmit data from/to another component or apparatus. The computer program product may use computer-readable program instructions stored on a computer-readable medium (e.g., memory) and executed by a processor 402. In various embodiments, the communication circuitry 406 (as with other components discussed herein) may be at least partially implemented as part of the processor 402 or otherwise controlled by the processor 402. The communication circuitry 406 may communicate with the processor 402, for example, through a bus 412. Such a bus 412 may connect to the processor 402, and it may also connect to one or more other components of the processor 402. The communication circuitry 406 may be comprised of, for example, transmitters, receivers, transceivers, network interface cards and/or supporting hardware and/or firmware/software and may be used for establishing communication with another component(s), apparatus(es), and/or system(s). The communication circuitry 406 may be configured to receive and/or transmit data that may be stored by memory by using one or more protocols that can be used for communication between components, apparatuses, and/or systems.

The input/output circuitry 408 may communicate with the processor 402 to receive instructions input by an operator and/or to provide audible, visual, mechanical, or other outputs to an operator. The input/output circuitry 408 may comprise supporting devices, such as a keyboard, a mouse, a user interface, a display, a touch screen display, lights (e.g., warning lights), indicators, speakers, and/or other input/output mechanisms. The input/output circuitry 408 may comprise one or more interfaces to which supporting devices may be connected. In various embodiments, aspects of the input/output circuitry 408 may be implemented on a device used by the operator to communicate with the processor 402. The input/output circuitry 408 may communicate with memory, the communication circuitry 406, and/or any other component, for example, through a bus 412.

The key generation circuitry 410 may be an example of a system, or a portion thereof, illustrated by and described with reference to FIG. 1. For example, the key generation circuitry 410 be an example of, or may be included in, a secure element illustrated by and described with reference to FIG. 1. The key generation circuitry 410 may include, or be otherwise coupled to (e.g., within the secure element), a CPU and secure storage. In some examples, the key generation circuitry is configured to support a true random-number generator and a secure timer, as well as additional mechanisms to resist package tampering and unauthorized sideloading of applications. In some examples, the key generation circuitry 410 includes a reboot notification pin (or equivalent), such as a GPIO. The key generation circuitry 410 may include a key generation service 414 (e.g., KeyMint), which may be an example of a key generation service illustrated by and described with reference to FIG. 1-3.

In some examples, the key generation circuitry 410 may obtain a first one or more commands to generate and store one or more cryptographic keys in the key generation service 414. In some such examples, in response to the first one or more commands, the key generation service 414 may generate the one or more cryptographic keys at the key generation service 414. For example, the key generation service 414 may use the true random-number generator (or one or more other components of the secure element) to generate the one or more cryptographic keys. In some examples, the key generation service 414 may store the one or more cryptographic keys at the key generation service 414. For example, the key generation service 414 may use the secure storage (or one or more other components of the secure element) to store the one or more cryptographic keys. In some examples, the key generation service 414 may obtain a second command to generate a cryptographic key for an application associated with the device 400. In some such examples, in response to the second command, the key generation service 414 may output at least a portion of one of the stored cryptographic keys. For example, the cryptographic keys may include RSA key pairs and, in response to the second command, the key generation service may output a public key of one of the RSA key pairs.

The device 400 may be implement in hardware, software, or a combination of hardware and software. In various embodiments, the device 400, or portions thereof, may be embodied in an integrated circuit, a microcontroller unit (MCU) (e.g., virtual machine running in an MCU), and/or the like. It should be readily appreciated that the embodiments of the systems, apparatuses, and methods described herein may be configured in various additional and alternative manners in addition to those expressly described herein.

### CONCLUSION

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present disclosure, the appended claims cover other embodiments of the present disclosure which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. A method comprising:
obtaining, at a cryptographic key generation service in a secure element of a device, a first one or more commands to generate and store one or more cryptographic keys in the cryptographic key generation service;
in response to the first one or more commands:
generating the one or more cryptographic keys at the cryptographic key generation service; and
storing the one or more cryptographic keys at the cryptographic key generation service;
obtaining, at the cryptographic key generation service, a second command to generate a cryptographic key for an application associated with the device; and
in response to the second command, outputting at least a portion of one of the one or more cryptographic keys stored at the cryptographic key generation service.

2. The method of claim 1, wherein obtaining the first one or more commands comprises:
obtaining the first one or more commands in accordance with a scheduled task.

3. The method of claim 2, wherein obtaining the first one or more commands in accordance with the scheduled task comprises:
obtaining the first one or more commands over a fixed duration.

4. The method of claim 1, further comprising:
in response to outputting the portion of the one of the one or more cryptographic keys, applying a flag to the one of the one or more cryptographic keys, wherein the flag indicates a status associated with the one of the one or more cryptographic keys.

5. The method of claim 4, wherein the status indicates that the one of the one or more cryptographic keys is unavailable for one or more other applications associated with the device.

6. The method of claim 1, further comprising:
incrementing a counter in response to storing the one or more cryptographic keys, wherein a count of the counter is based at least in part on a quantity of cryptographic keys included in the one or more cryptographic keys.

7. The method of claim 6, further comprising:
obtaining, at the cryptographic key generation service, a third command to generate and store another cryptographic key in the cryptographic key generation service; and
in response to the third command, outputting a message comprising an error code based at least in part on the count of the counter satisfying a threshold.

8. The method of claim 7, further comprising:
decrementing the counter in response to outputting the portion of the one of the one or more cryptographic keys.

9. The method of claim 1, wherein obtaining at least one of the first one or more commands is based at least in part on a level of performance of at least one application associated with the device failing to satisfy a threshold.

10. The method of claim 1, wherein the secure element comprises an embedded secure element (eSE) or an integrated secure element (iSE).

11. The method of claim 1, wherein the one of the one or more cryptographic keys comprises a cryptographic key pair including a public key and a private key, and wherein the portion of the one of the one or more cryptographic keys comprises the public key.

12. The method of claim 1, wherein the one or more cryptographic keys comprise one or more Rivest-Shamir-Adleman (RSA) key pairs.

13. The method of claim 1, wherein the cryptographic key generation service is KeyMint.

14. A method comprising:
outputting, to a cryptographic key generation service in a secure element of a device, a first one or more commands to generate and store one or more cryptographic keys in the cryptographic key generation service;
outputting, to the cryptographic key generation service, a second command to generate a cryptographic key for an application associated with the device; and
in response to the second command, obtaining at least a portion of one of the one or more cryptographic keys from the cryptographic key generation service.

15. The method of claim 14, wherein outputting the first one or more commands comprises:
outputting the first one or more commands in accordance with a scheduled task.

16. The method of claim 15, wherein outputting the first one or more commands in accordance with the scheduled task comprises:
outputting the first one or more commands over a fixed duration.

17. The method of claim 14, further comprising:
outputting, to the cryptographic key generation service, a third command to generate and store another cryptographic key in the cryptographic key generation service;
in response to the third command, obtaining a message comprising an error code; and
in response to the error code, refraining from outputting other commands to generate and store other cryptographic keys at the cryptographic key generation service.

18. The method of claim 14, wherein outputting at least one of the first one or more commands is based at least in part on a level of performance of at least one application associated with the device failing to satisfy a threshold.

19. The method of claim 14, wherein the one of the one or more cryptographic keys comprises a cryptographic key pair including a public key and a private key, and wherein the portion of the one of the one or more cryptographic keys comprises the public key.

20. A system comprising:
a cryptographic key generation service in a secure element, wherein the cryptographic key generation service configured to:
obtain a first one or more commands to generate and store one or more cryptographic keys in the cryptographic key generation service;
in response to the first one or more commands, generate and store the one or more cryptographic keys;
obtain a second command to generate a cryptographic key for an application associated with the system; and
in response to the second command, output at least a portion of one of the one or more cryptographic keys.
